(19) United States
(12) Patent Application Publication
(10) Pub. No.: US 2012/0147470 A1
(43) Pub. Date: Jun. 14, 2012

(54) SECURITY DEVICE

(76) Inventors: Martin Klenke, Blieskastel (DE); Matthias Henyk, Bodman-Ludwigshafen (DE)

(21) Appl. No.: 13/263,200

(22) PCT Filed: Apr. 7, 2010
(86) PCT No.: PCT/EP10/54609

§ 371 Date: Dec. 27, 2011

Related U.S. Application Data
(60) Provisional application No. 61/167,421, filed on Apr. 7, 2009.

(30) Foreign Application Priority Data
Apr. 7, 2009 (EP) 09157495.4

(51) Int. Cl. G02B 27/44

(52) U.S. Cl. 359/567

(57) ABSTRACT

A security device, which is suitable in particular for improving the anti-forgery security of payment means, wherein the security device comprises a flat light reflection element. Several three-dimensional diffractive surface elements are arranged on a surface of the light reflection element. The surface elements comprise a diffraction grating on a light outlet surface. The diffraction gratings of a group of light surface elements are designed and/or arranged in such a way that an asterism is produced for an observer and/or an examination device.

### BACKGROUND

1. Field of the Invention

The present disclosure relates to a safety device, particularly for improved protection against forgery of means of payment.

2. Discussion of the Background Art

Safety devices are used e.g. for the marking of trademark products and particularly of means of payment such as credit cards, banknotes and the like. These safety devices can be e.g. safety devices of the type which is visible to the human eye, such as holograms, for instance. Further, safety devices are known which are not visible to the human eye or are visible only if exposed to a special light, wherein such safety devices are generated e.g. by color pigments applied to the means of payment. Thus, in spite of the large number of existing safety devices, a need exists for the development of safety devices which are reliably forgery-safe.

Therefore, it is an object of the disclosure to provide a further safety device, designed as an optical safety device, which provides increased protection against forgery e.g. of means of payment.

### SUMMARY

The safety device of the disclosure comprises an areal light reflection element. Said light reflection element can be realized e.g. by an aluminum foil, a silver foil or another metal foil generating a reflection. According to a preferred embodiment, there is provided a light reflection element having a highly reflective surface so as to cause minimal refraction and diffraction effects and, preferably, no such effects at all. According to the disclosure, a surface of the light reflection element has three-dimensional diffractive surface elements arranged thereon. Said surface elements bring about a diffraction of the light reflected on the light reflection element. Said diffraction of the light will be performed in the direction toward an observer, i.e. towards a human eye or towards an automated verification device. According to the disclosure, the individual surface elements are provided with different diffraction gratings on a light exit surface. Thus, in case of a large number of surface elements, at least two different diffraction gratings are provided. The surface elements are combined into an array, wherein the individual surface elements of the array are formed and/or arranged in such a manner that an asterism will be generated for the user and the verification device, respectively. This is to say that, according to the disclosure, the incident light reflected by the light reflection element will be diffracted by the diffraction gratings of the surface elements in a manner causing the user to perceive an asterism. In the most simple embodiment, the asterism can occur in the form of a single straight line. With preference, however, the asterism comprises a plurality of lines, which preferably are arranged in a star-shaped configuration. These preferably plural lines intersect each other in a sole, preferably central point. Generated thereby, in a manner similar to the asterism occurring in mineralogy, is a star consisting of a configuration of lines including a central bright spot. In mineralogy, asterism occurs especially in star sapphires, star rubies and star corundums. The asterism is thus effective to generate a concentration of light in the direction towards the observer and the verification device, respectively.

According to a preferred embodiment, the asterism can be perceived by the observer and respectively the verification device within a relatively large angular range. In this situation, the visual impression does not change as long as the observation of the safety device by the observer or the verification device will take place within said angular range. With preference, the angular range is 90°±20° relative to the surface of the light reflection element. Preferably, the asterism can be perceived within an angular range of 90°±45° and more preferably 90°±60°. Particularly to the human eye, a tilting of the safety device within the predetermined angular range will not cause a change of the visual impression. Especially the central bright spot where a plurality of lines of the asterism intersect each other, does not change its position or at least merely insubstantially so.

The individual surface elements of a surface element array are formed and/or arranged in such a manner that the radiation direction of the light, as resulting from the diffraction at the exit surface, will generate an asterism.

According to the disclosure, since the resolution of the human eye is limited, it is preferred to provide the individual surface elements with exit surfaces of the smallest possible sizes. Preferably, the exit surfaces have a size of less than 30 μm² and more preferably less than 25 μm². Further, it is preferred that the distances between the individual surface elements are small. The distances are preferably in the range of 0-100 μm and more preferably 0-50 μm.

Further, according to the disclosure, the distance between the exit surface of the surface elements where the diffraction grating is arranged, on the one hand, and the surface of the light reflection element, on the other hand, is preferably small. This distance is preferably in the range of 1-300 μm and more preferably 1-200 μm. In this regard, it is particularly preferred to produce the individual surface elements—preferably all of them together—by molding a lacquer. A suitable material for producing the surface elements or an array comprising a plurality of surface elements preferably has the following composition:

11 g of 1H, 1H, 2H, 2H perfluorooctyl acrylate was mixed with 8 g of dipropylene glycol diacrylate, 0.1 g of Irgacure ® 819 and 0.2 g Irgacure ® 184 of the company Ciba Spezialitaenchemie Lampersheim GmbH. 60 μl of this mixture was applied to a nickel plate sized 2×2 cm and on its surface presenting a negative mold of a molded body with scattering centers. Thereafter, a plate of PMMA having a thickness of 1 mm and a size of 1×1 cm was applied to the surface of said mixture on the nickel plate. Then, the thus obtained sandwich structure on the nickel plate with the interposed mixture was subjected for 2 seconds to UV radiation from a commercially available UV mercury lamp. Subsequently, the substrate together with the attached hardened molding composition was removed from the negative mold.

The layer thickness obtained thereby is preferably 1-300 μm and more preferably 1-200 μm. With particular preference, the lacquer for producing the surface elements will be applied directly onto the light reflection element, be molded and be cured, e.g. by UV radiation.

For generating the asterism according to the disclosure, the diffraction gratings of the individual surface elements preferably have a frequency smaller than ¼ of the wavelength of the incident light. Preferably, the frequency of the diffraction grating is less than 100 nm, more preferably less than 50 nm.

The diffraction grating itself preferably has an wave-shaped profile, wherein the individual flanks of the wave-shaped profile can have an irregular flank slope. However, the profile can also be a regular sinusoidal profile, a rectangular profile or a sawtooth profile, or a combination of different profiles.

The asterism generated according to the disclosure is preferably perceivable by the human eye so that the checking of the safety device and thus e.g. the verifying of the authenticity of means of payment can be performed without auxiliary means. However, it can also be provided, e.g., that the asterism is generated only when using incident light of specific wavelengths or wavelength ranges and, e.g., that a plurality of light sources are required which will generate illumination from different directions. Preferably, such light sources will be point light sources illuminating the safety device from different directions. The thus obtained asterism will then be detectable by an optical verification device.

With particular preference, the safety device of the disclosure can be combined with other safety devices which will generate e.g. holograms and the like. Preferably, the safety device of the disclosure can be integrated into another optical safety device.

The above described arrangement of three-dimensional diffractive surface elements on a light reflection element is not restricted to safety devices. Instead, the above design of the surface elements for generating an asterism is also suited for use in other reflectors.

A preferred embodiment of the disclosure will be described in greater detail hereunder with reference to the accompanying drawings.

### BRIEF DESCRIPTION OF THE DRAWINGS

In the drawings, the following is shown:

FIG. 1 is a schematic sectional view of a safety device according to the disclosure;

FIG. 2 is a schematic perspective view of an individual surface element;

FIG. 3 shows different schematic views of asterisms visible to the observer.

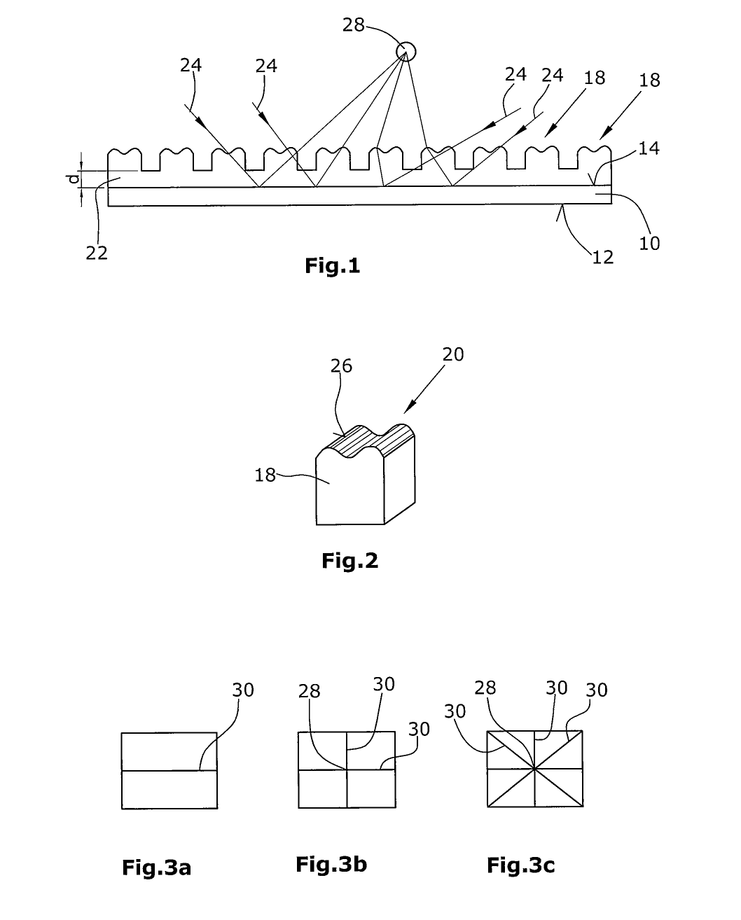

### DETAILED DESCRIPTION OF THE PREFERRED EMBODIMENT

The safety device according to the disclosure comprises a light reflection element 10 which can be an aluminum foil, for instance. Said light reflection element 10 is arranged by its underside 12 on a product to be protected, such as e.g. a credit card, a banknote or the like. On an upper face 14 of the light reflection element, a plurality of diffractive surface elements 18 are arranged. The individual surface elements 18 comprise a light exit surface 20 with a diffraction grating. Preferably, the individual surface elements 18, which are combined into an array of surface elements 18, are produced together by applying a lacquer onto the upper face 14 of light reflection element 10 and molding the individual surface elements with the aid of a molding element. Preferably, in this regard, use made of a lacquer which is curable by UV radiation. After the molding of the surface elements 18, the layer of lacquer 22 preferably has a thickness d of 1-300 μm.

Subsequent to a possible diffraction occurring already upon entrance into said lacquer layer, incident light beams 24 will be reflected on the upper face 14 of light reflection element 10. When exiting from the surface elements, the light beams are diffracted in such a manner by the diffraction grating arranged on the outer surface 26 (FIG. 2) of the individual surface elements 20 that the light beams will meet at a common point 28.

Said diffraction takes place in such a manner that, in the most simple embodiment, a line 30 (FIG. 3a) will be generated when viewed from above.

Further, it can be provided that a plurality of lines 30 are generated (FIGS. 3b,3c), with all of the lines 30 intersecting at a common central point 28. The observer will thus perceive an asterism e.g. as illustrated in FIG. 3.

What is claimed is:

1. A safety device, particularly for improved protection against forgery of means of payment, said safety device comprising:
an areal light reflection element;
three-dimensional diffractive surface elements arranged on a surface of the light reflection element, for diffraction, in the direction towards an observer or a verification device, of light reflected on the light reflection element;
the individual surface elements comprising different diffraction gratings on a light exit surface,
the diffraction gratings of an array of surface elements being formed and/or arranged to generate an asterism to be perceived by the observer and the verification device, respectively.

2. The safety device according to claim 1, wherein the radiation directions of the individual surface elements of an array of surface elements have been mutually adjusted so as to generate said asterism.

3. The safety device according to claim 1, wherein said exit surface has a cross-sectional area of less than 30 μm², preferably less than 25 μm².

4. The safety device according to claim 1, wherein the distance between the exit surface of the surface elements and the surface of the light reflection element is 1-300 μm.

5. The safety device according to claim 4, wherein the surface elements are produced by molding a lacquer, the layer thickness (d) being 1-300 μm.

6. The safety device according to claim 5, wherein the surface elements of an array of surface elements have been molded together with each other.

7. The safety device according to claim 1, wherein the diffraction grating of the surface elements has a frequency of less than ¼ of the wavelength of the incident light, preferably less than 100 nm.

8. The safety device according to claim 1, wherein the diffraction grating has a wave-shaped profile, preferably with unequal flank slopes.

9. The safety device according to claim 1, wherein the distance between the surface elements is 0-100 μm.

10. The safety device according to claim 1, wherein the generated asterism is automatically detectable by a mechanical verification device.

11. The safety device according to claim 1, wherein the same asterism is visible from different observation angles.

12. The safety device according to claim 11, wherein the observation angle relative to the surface of the light reflection element is 90°+20°.

13. The safety device according to claim 12, wherein the surface elements are integrated in a further safety element.

14. The safety device according to claim 1, wherein the asterism comprises at least one straight line.

15. The safety device according to claim 1, wherein the asterism comprises a plurality of straight lines intersecting each other in a point.

16. The safety device according to claim 4, wherein said surface of the light reflection element is between about 1-200 μm.

17. The safety device according to claim 5, wherein the layer thickness is between about 1-200 μm

18. The safety device according to claim 7, wherein said frequency is less than 50 nm.

19. The safety device according to claim 9, wherein said distance between the surface elements is between about 0-50 μm.

20. The safety device according to claim 12, wherein said observation angle is between about 90°±45°.
